(19) United States
(12) Patent Application Publication
(10) Pub. No.: US 2016/0373235 A1
(43) Pub. Date: Dec. 22, 2016

(54) METHOD AND APPARATUS FOR PERFORMING COMMUNICATION IN WIRELESS COMMUNICATION SYSTEM

(71) Applicant: Samsung Electronics Co., Ltd., Suwon-si (KR)

(72) Inventors: Jin-Young OH, Seoul (KR); Youn-Sun KIM, Seongnam-si (KR); Chae-Man LIM, Seoul (KR); Sang-Bum KIM, Suwon-si (KR); Jae-Hyuk JANG, Suwon-si (KR)

(21) Appl. No.: 15/189,690

(22) Filed: Jun. 22, 2016

Related U.S. Application Data
(60) Provisional application No. 62/182,770, filed on Jun. 22, 2015.

(51) Int. Cl. H04L 5/14; H04L 5/00; H04L 1/18; H04W 72/04

(52) U.S. Cl. CPC H04L 5/14; H04W 72/0446; H04L 5/0048; H04L 1/18; H04W 72/0406; H04W 88/02

(57) ABSTRACT

The present disclosure relates to a communication scheme and system for converging a 5-th generation (5G) communication system for supporting a higher data rate beyond a 4-th generation (4G) system with an internet of things (IoT) technology. The present disclosure is applicable to intelligent services (e.g., smart homes, smart buildings, smart cities, smart cars, connected cars, health care, digital education, retails, security, safety-related services, and so forth) based on the 5G communication technology and the IoT-related technology. In an embodiment of the present disclosure, in a wireless communication system, a user equipment (UE) receives control information about a secondary cell (SCell) from a primary cell (PCell) via a licensed band and communicates with PCell via the licensed band channel in an unoccupy window for an unlicensed band channel of SCell.

### CROSS-REFERENCE TO RELATED APPLICATION(S)

This application claims the benefit under 35 U.S.C. §119(e) of a U.S. Provisional application filed on Jun. 22, 2015 in the U.S. Patent and Trademark Office and assigned Ser. No. 62/182,770, the entire disclosure of which is hereby incorporated by reference.

### TECHNICAL FIELD

The present disclosure relates to a method and apparatus for performing communication in a wireless communication system.

### BACKGROUND

To satisfy demands for wireless data traffic having increased since commercialization of 4th-generation (4G) communication systems, efforts have been made to develop improved 5th-generation (5G) communication systems or pre-5G communication systems. For this reason, the 5G communication system or the pre-5G communication system is also called a beyond-4G-network communication system or a post-long term evolution (LTE) system.

To achieve a high data rate, implementation of the 5G communication system in an ultra-high frequency (mmWave) band (e.g., a 60 GHz band) is under consideration. In the 5G communication system, beamforming, massive multi-input multi-output (MIMO), full dimensional MIMO (FD-MIMO), an array antenna, analog beamforming, and large-scale antenna technologies have been discussed to alleviate a propagation path loss and to increase a propagation distance in the ultra-high frequency band.

For system network improvement, in the 5G communication system, techniques such as an evolved small cell, an advanced small cell, a cloud radio access network (RAN), an ultra-dense network, a device to device (D2D) communication, a wireless backhaul, a moving network, cooperative communication, coordinated multi-points (CoMPs), and interference cancellation have been developed.

In the 5G system, advanced coding modulation (ACM) schemes including hybrid frequency-shift keying (FSK) and quadrature amplitude modulation (QAM) modulation (FQAM) and sliding window superposition coding (SWSC), and advanced access schemes including filter bank multi carrier (FBMC), non-orthogonal multiple access (NOMA), and sparse code multiple access (SCMA) have been developed.

Internet, which is a human-oriented connectivity network where humans generate and consume information, is now evolving to the internet of things (IoT) where distributed entities, such as things, exchange and process information. The internet of everything (IoE) has also emerged, which is a combination of the IoT technology and the big data processing technology via connection with a cloud server.

As technology elements, such as sensing technology, wired/wireless communication and network infrastructure, service interface technology, and security technology, have been demanded for IoT implementation, a sensor network, a machine to machine (M2M), machine type communication (MTC), and so forth have been recently researched for connection between things.

Such an IoT environment may provide intelligent internet technology (IT) services that create a new value to human life by collecting and analyzing data generated among connected things. IoT may be applied to a variety of fields including smart home, smart building, smart city, smart car or connected cars, smart grid, health care, smart appliances, advanced medical services, and so forth via convergence and combination between existing IT and various industries.

Thus, various attempts have been made to apply 5G communication systems to IoT networks. For example, 5G communication technologies such as sensor networks, things communication, MTC, etc., have been implemented by schemes such as beamforming, MIMO, array antennas, and so forth. Application of the cloud RAN as the Big Data Processing technology may also be an example of convergence of the 5G technology and the IoT technology.

Current mobile communication systems are evolving to high-speed, high-quality wireless packet data communication systems to provide data services and multimedia services beyond the initial versions that have provided voice-centered services. To provide the high-speed, high-quality wireless packet data transmission services, various mobile communication standards including high speed downlink packet access (HSDPA) of the 3rd generation partnership project (3GPP), high speed uplink packet access (HSUPA), LTE, LTE advanced (LTE-A), high rate packet data (HRPD) of the 3GPP2, 802.16 of the institute of electrical and electronics engineers (IEEE), and so forth have been developed. In particular, the LTE/LTE-A system (hereinafter, LTE system) happened to have the maximum frequency efficiency while undergoing continuous development of standards and evolution. Further, data transmission rate and system capability have been maximized using carrier aggregation (CA) by which the system may be operated via multiple frequency bands. However, the frequency band operated by the current LTE system is the licensed band (the licensed spectrum or licensed carrier) which the service provider generally has a dedicated right to use. Generally, since the frequency band (e.g., a 5 GHz or less frequency band) on which mobile communication services are now being offered is already occupied and used by other service providers or other communication systems, the service provider has difficulty securing and operating multiple licensed bands to expand the system capability.

There are being recently researched techniques to utilize the LTE system on the unlicensed band (unlicensed spectrum or unlicensed carrier) relatively easy to secure in order to process mobile data that explosively increases and to address the issue of securing frequency. Among frequency bands in the unlicensed bands, the 5 GHz band is especially used by a small number of devices and allows use of a broad bandwidth. Thus, when the 5 GHz band in the unlicensed band is used, the LTE system capacity is easy to be maximized.

For example, based on the aforementioned CA technology, which is one of core technologies of the LTE systems, multiple frequency bands may be used. That is, an LTE cell in a licensed band may be regarded as a primary cell (PCell or Pcell) and an LTE cell (licensed assisted access (LAA) cell or LTE-unlicensed spectrum (LTE-U) cell) in an unlicensed band may be regarded as a secondary cell (SCell or Scell) to operate the LTE system in the unlicensed band in the same manner as or in a similar manner to an existing CA environment. In this case, the system may be applicable to the dual-connectivity environment where the licensed band and the unlicensed band are connected with each other via a non-ideal backhaul as well as the CA where the licensed band and the unlicensed band are connected with each other via an ideal backhaul.

Meanwhile, installation of an antenna used for data transmission and reception may be limited due to size constraints for small-size devices such as terminals or user equipments (UEs). That is, installation of multiple antennas for a plurality of wireless communication systems using different communication schemes in one UE has a limitation. As a result, generally, one antenna is used for a plurality of wireless communication systems in a UE. For example, in a UE, communication using a first communication scheme and communication using a second communication scheme may be performed via one antenna.

However, one antenna may not be used at the same point in time for multiple communications, and thus, the communication using the first communication scheme and the communication using the second communication scheme may not be performed at the same time. Hence, there is a need for a detailed scheme for allowing the communication using the first communication scheme and the communication using the second communication scheme to be performed temporally separately in the UE and for a procedure with a base station for the two communication schemes.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus which allows a wireless communication system in a licensed band to correctly operate in an unlicensed band.

Another aspect of the present disclosure is to provide a method and apparatus which allows coexistence and use of a plurality of wireless communication systems using different communication schemes in a device supporting the plurality of wireless communication systems.

In accordance with an aspect of the present disclosure, a method for performing communication by a user equipment (UE) in a wireless communication system is provided. The method includes receiving control information about a second cell from a first cell via a licensed band channel, performing communication with the second cell based on a first communication scheme via an unlicensed band channel of the second cell in an occupy window of the unlicensed band channel based on the control information, and performing communication with a third cell based on a second communication scheme via the unlicensed band channel of the second cell in an unoccupy window of the unlicensed band channel based on the control information.

In accordance with another aspect of the present disclosure, a method for performing communication by a first cell in a wireless communication system is provided. The method includes transmitting control information comprising information about an occupy window and an unoccupied window for an unlicensed band channel of a second cell to a UE via a licensed band, in which the occupy window indicates a window where the UE performs communication with the second cell via the unlicensed band channel based on a first communication scheme, and the unoccupy window indicates a window where the UE performs communication with a third cell via the unlicensed band channel based on a second communication scheme.

In accordance with another aspect of the present disclosure, a UE in a wireless communication system is provided. The UE includes a transceiver configured to receive control information about a second cell from a first cell via a licensed band channel and a controller configured to perform communication with the second cell based on a first communication scheme via an unlicensed band channel in an occupy window of the unlicensed band channel of the second cell based on the control information and to perform communication with a third cell based on a second communication scheme via the unlicensed band channel in an unoccupy window of the unlicensed band channel of the second cell based on the control information.

In accordance with another aspect of the present disclosure, a first cell in a wireless communication system is provided. The first cell includes a transceiver configured to transmit control information including information about an occupy window and an unoccupy window for an unlicensed band channel of a second cell to a UE via a licensed band, in which the occupy window indicates a window where the UE performs communication with the second cell via the unlicensed band channel based on a first communication scheme, and the unoccupy window indicates a window where the UE performs communication with a third cell via the unlicensed band channel based on a second communication scheme.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates an example of a wireless communication system according to an embodiment of the present disclosure;

FIG. 1B illustrates another example of a wireless communication system according to an embodiment of the present disclosure;

FIG. 2 illustrates an example of a long term evolution unlicensed spectrum (LTE-U) ON window and an LTE-OFF window in an unlicensed band according to an embodiment of the present disclosure;

FIG. 3 illustrates an example of a time division duplexing (TDD) uplink (UL)/downlink (DL) configuration in an unlicensed band according to an embodiment of the present disclosure;

FIGS. 4A, 4B, and 4C illustrate an example of a reinterpreted TDD UL/DL configuration according to an embodiment of the present disclosure;

FIG. 5 is a flowchart illustrating a base station operation according to an embodiment of the present disclosure;

FIG. 6 is a flowchart illustrating a user equipment (UE) operation according to an embodiment of the present disclosure;

FIG. 7 is a block diagram of a base station according to an embodiment of the present disclosure; and

FIG. 8 is a block diagram of a UE according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, according to this disclosure, the long term evolution (LTE) system and the LTE-advanced (LTE-A) system are described as examples, but the present disclosure may also apply to other communication systems using a licensed band and unlicensed band without limited thereto.

Although only carrier aggregation (CA) environments are assumed and described for ease of description, the present disclosure is not limited thereto and may also be applicable to stand-alone environments in which it operates only under dual-connectivity or unlicensed band environments.

In an embodiment of the present disclosure, for ease of a description, the description will be made based on a downlink (DL) in which the base station transmits data to the user equipment (UE) in the LTE system. That is, the transmission device requiring signal transmission is represented as the base station, and the transmission device requiring signal reception is represented as the UE. However, the present disclosure may also be applicable to an uplink (UL) where transmission occurs from the UE to the base station without limitations as well as the DL and may apply in the operation of the general transmission device or reception device.

In an embodiment of the present disclosure, in a wireless communication system, a UE receives control information about a second cell from a first cell via a licensed band channel, performs communication with the second cell based on a first communication scheme via an unlicensed band channel in an occupy window of the unlicensed band channel of the second cell based on the control information, and performs communication with a third cell based on a second communication scheme via the unlicensed band channel in an unoccupy window of the unlicensed band channel of the second cell based on the control information. The first communication scheme may be an LTE or LTE-A communication scheme, and the first cell and the second cell may be primary cell (PCell) and secondary cell (SCell) that perform communication with a UE based on the first communication scheme. The second communication scheme indicates a communication scheme that is different from the first communication scheme like Wi-Fi, and the third cell may be a cell for Wi-Fi communication or a 5G cell.

Hereinafter, an embodiment of the present disclosure will be described in detail.

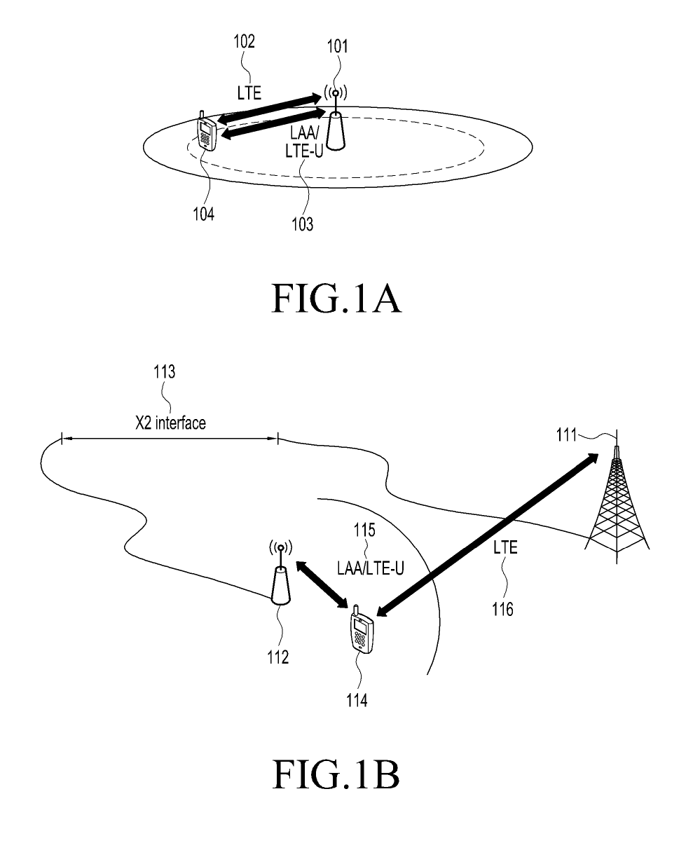

FIG. 1A illustrates an example of a wireless communication system according to an embodiment of the present disclosure.

Referring to FIG. 1A, the wireless communication system may include a base station 101 and a UE 104. The base station 101 may be, for example, a small-size or small base station, and a cell of the base station 101 may include an LTE cell 102 and an LTE unlicensed spectrum (LTE-U) cell 103. The LTE cell 102 indicates a cell in which the UE 104 may perform data transmission and reception to and from the base station 101 using a licensed band. The LTE-U cell 103 indicates a cell in which the UE 104 may perform data transmission and reception to and from the base station 101 using an unlicensed band. There is no limitation on the duplex scheme of the LTE cell 102 or LTE-U cell 103. However, UL transmission may be limited to be performed only via the LTE cell 102 in case the LTE cell 102 is a PCell.

FIG. 1B illustrates another example of a wireless communication system according to an embodiment of the present disclosure.

Referring to FIG. 1B, the wireless communication system may include an LTE macro base station 111 for wide coverage and an LTE-U small base station 112 for increasing a data transfer rate. A UE 114 performs data transmission and reception to and from the LTE macro base station 111 by using a licensed band 116, and performs data transmission and reception to and from the LTE macro base station 111 by using an unlicensed band 115. There is no limitation on the duplex scheme of the LTE macro base station 111 or LTE-U small base station 112. However, UL transmission may be set to be performed only via the LTE macro base station 111 if the LTE macro base station 111 is a PCell. The LTE macro base station 111 and the LTE-U small base station 112 may have an ideal backhaul network based on a base station interface such as an X2 interface 113. Accordingly, even when high-speed communication is possible between the base stations, so that UL transmission is performed only via the LTE macro base station 111, the LTE-U small base station 112 may receive relevant control information from the LTE macro base station 111 in real-time via the communication between the base stations.

Schemes proposed in an embodiment of the present disclosure are applicable to both the wireless communication system illustrated in FIG. 1A and the wireless communication system illustrated in FIG. 1B.

Generally, the unlicensed band (e.g., a 2.4 GHz or 5 GHz band) includes a plurality of channels, one of which includes a specific frequency band (e.g., 20 MHz). Wireless communication devices such as UEs may perform wireless communication using at least one of a plurality of channels of an unlicensed band. To occupy a plurality of channels, wireless communication devices may perform a separate channel sensing operation for each channel and perform a single channel sensing operation for all channels to be used. Thus, depending on a result of the channel sensing operation, the wireless communication devices may simultaneously use a plurality of channels or one or some of the plurality of channels to perform wireless communication. Herein below, in an embodiment of the present disclosure, the unlicensed band refers to the whole 2.4 GHz or 5 GHz frequency band, and the channel refers to a frequency band having a predetermined bandwidth in the unlicensed band.

If there is no regulation regarding a channel sensing operation (or listen-before-talk (LBT) required for channel occupancy in the unlicensed band like in US, the LTE system may freely occupy and use the unlicensed band without a separate channel sensing operation. Hereinafter, a system where the LTE system freely occupies the unlicensed band without the channel sensing operation and performs communication will be referred to as an LTE-U system. An embodiment of the present disclosure is applicable to a system freely occupying the unlicensed band without the channel sensing operation and a system occupying the unlicensed band based on the channel sensing operation (e.g., a licensed assisted access (LAA) system). In other words, the present disclosure may be applied to any device supporting a plurality of wireless communication systems.

That is, the LTE-U system freely starts occupying the unlicensed band regardless of whether other devices occupy the unlicensed band or a corresponding channel at a desired time, and continuously occupies the unlicensed band without a separate restriction.

However, if the LTE-U system continuously occupies and uses the unlicensed band, a system (e.g., Wi-Fi, Bluetooth, etc.) performing a channel sensing operation to occupy the unlicensed band in spite of no restriction regarding the channel sensing operation for the unlicensed band may not occupy a channel due to the channel occupancy of the LTE-U system, or performance may be degraded due to reduction in the channel occupy time of the systems. Thus, for coexistence with a system (e.g., a Wi-Fi system) that performs a channel sensing operation for occupying the unlicensed band, the LTE-U system may operate by periodically or aperiodically setting a channel unoccupied time and/or a channel occupied time.

For example, the LTE-U system may operate the LTE-U system by periodically or aperiodically setting an LTE-U ON window where the LTE-U transmission is performed in the unlicensed band and an LTE-U OFF window where the LTE-U transmission is not performed in the unlicensed band. The LTE-U ON window and the LTE-U OFF window of the unlicensed band may be defined previously or may be reset according to a predetermined interval or a particular condition (e.g., unlicensed band occupancy rate or measured interference strength of other devices), and may be set differently for a plurality of channels of the unlicensed band.

Thus, wireless communication is performed using the LTE-U system in the LTE-U ON window of the unlicensed band, and another wireless communication system using the unlicensed band, such as the Wi-Fi system, may use the unlicensed band in the LTE-U OFF window of the unlicensed band. The LTE-U system monitors whether another wireless communication system using the unlicensed band, such as the Wi-Fi system, uses the unlicensed band in the LTE-U OFF window of the unlicensed band.

For example, in the LTE-U OFF window of the unlicensed band, the LTE-U base station measures information about channel occupancy of other wireless communication systems (e.g., a Wi-Fi system) occupying and using the unlicensed band and uses the information to set later the LTE-U ON window or interval (or period) of the unlicensed band and the LTE-U OFF window or interval of the unlicensed band. The information about channel occupancy may include, for example, a channel occupancy rate, the number of channel-occupying devices, a strength of a signal received from a channel-occupying device, and so forth.

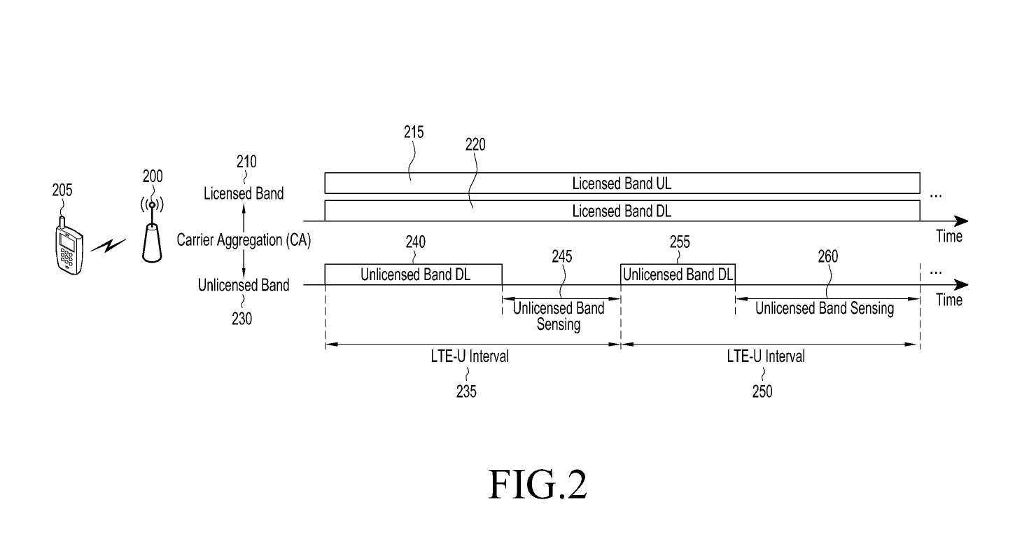

With reference to FIG. 2, a description will be made of a method for setting an LTE-ON window and an LTE-OFF window in an unlicensed band.

FIG. 2 illustrates an example of an LTE-U ON window and an LTE-OFF window in an unlicensed band according to an embodiment of the present disclosure.

Referring to FIG. 2, an LTE-U base station 200 performs communication with an LTE-U UE 205 by using CA using at least one frequency (or channel) of a licensed band 210 and at least one frequency (or channel) of an unlicensed band 230. If the LTE-U base station 200 and the LTE-U UE 205 are operable without a separate channel sensing operation for channel occupancy of the unlicensed band 230, the LTE-U base station 200 freely occupies one channel or a plurality of channels of the unlicensed band to perform DL or UL communication with the LTE-U UE 205. In an embodiment of the present disclosure, for ease of a description, the description will be made on the assumption that only DL communication is performed between the LTE-U base station 200 and the LTE-U UE 205 in the unlicensed band 230. However, an embodiment of the present disclosure is also applicable to a case where communication in the unlicensed band 230 is performed regardless of DL or UL.

If the LTE-U base station 200 is set to perform only DL communication, without performing UL transmission, in the unlicensed channel 230, the LTE-U base station 200 and the LTE-U UE 205 may perform UL communication by using a UL 215 of the licensed band 210. By contrast, if the LTE-U base station 200 is set to perform only UL communication, without performing DL transmission, in the unlicensed channel 230, the LTE-U base station 200 and the LTE-U UE 205 may perform DL communication by using a DL 220 of the licensed band 210.

In an embodiment of the present disclosure, for ease of a description, the description is made based on a case where communication is performed between the LTE-U base station 200 and the LTE-U UE 205 by using one of channels of the unlicensed band 230, but a method according to an embodiment of the present disclosure is also applicable to communication between the LTE-U base station 200 and the LTE-U UE 205 by using a plurality of channels of the unlicensed band.

If the LTE-U base station 200 starts occupying a channel of the unlicensed band 230 without a separate channel sensing operation and continuously occupies a channel of the unlicensed band 230, other systems (e.g., the Wi-Fi system) that are set to perform the channel sensing operation before using the channel of the unlicensed band 230 may not occupy the channel of the unlicensed band 230 or an opportunity for the systems to occupy the channel of the unlicensed band 230 may be reduced. Thus, the LTE-U base station 200 sets LTE-U intervals 235 and 250 to share and use a channel of the unlicensed band 230 with other systems using the unlicensed band, such as the Wi-Fi system. The LTE-U base station 200 sets LTE-U ON windows 240 and 255 in which a channel of the unlicensed band 230 is occupied, and/or LTE-U OFF windows 245 and 260 in which a channel of the unlicensed band 230 is not occupied, in the LTE-U intervals 235 and 250.

The LTE-U base station 200 then performs LTE-U communication in the LTE-U ON windows 240 and 255, and performs channel monitoring or measurement for a channel of the unlicensed band 230 in the LTE-U OFF windows 245 and 260. For example, the LTE-U base station 200 and/or the LTE-U UE 205 may acquire information about other systems that occupy a channel of the unlicensed band 230 in the LTE-U OFF windows 245 and 260 and perform communication.

The operation of acquiring the information about another system may include an operation of acquiring various information including a time or rate in which other systems or devices occupy the channel in the LTE-U OFF windows 245 and 260, a type, a number, or a rate of systems or devices occupying the channel, and a strength or rate of a signal received from devices occupying the channel.

The LTE-U intervals 235 and 250 may be defined in advance, or may be changed or reset according to at least one of the various information, measured by the LTE-U system, about other wireless communication systems (e.g., the Wi-Fi system) that occupy and use the unlicensed band, or the interval or window may be changed or reset based on a predefined time or periodically. In an embodiment of the present disclosure, for ease of a description, the description will be made on the assumption that the LTE-U base station 200 sets the LTE-U intervals 235 and 250. However, a method according to an embodiment of the present disclosure is applicable without setting the LTE-U intervals 235 and 250.

For example, the LTE-U base station 200 may operate the LTE-U system in the unlicensed band 230 by setting the LTE-U intervals 235 and 250 for the unlicensed band 230 to 100 ms, setting 60 ms as the LTE-U ON windows 240 and 255 in the LTE-U intervals 235 and 250, and setting the remaining 40 ms as the LTE-U OFF windows 245 and 260.

The set LTE-U intervals may be changed or reset for every interval. For example, the LTE-U interval 235 and the LTE-U interval 250 may be set identical or different. The LTE-U ON window and/or the LTE-U OFF window may be changed or reset for every LTE-U period. For example, the LTE-U ON window 240 and the LTE-U OFF window 245 in the LTE-U interval 235 may be set different from the LTE-U ON window 255 and the LTE-U OFF window 260 in the LTE-U interval 250.

The LTE-U intervals 235 and 250, the LTE-U ON windows 240 and 255, and the LTE-U OFF windows 245 and 260 may be changed or reset based on the information, measured by the LTE-U system, about other wireless communication systems (e.g., the Wi-Fi system) occupying and using the unlicensed band 230, or may be changed or reset based on a predefined time or periodically.

For example, the LTE-U base station 200 or UE 205 may perform a channel monitoring operation with respect to a channel of the unlicensed band 230 in the LTE-U OFF window 245 and measure occupancy state information regarding the channel of the unlicensed band 230 for other wireless communication devices sensed or detected in the LTE-U OFF window 245. The LTE-U base station 200 or UE 205 may change later a channel occupying operation with respect to the unlicensed band according to the measured information.

In other words, if it is determined that other communication devices continuously occupy and use a channel of the unlicensed band 230 in the LTE-U OFF window 245, the LTE-U base station 200 reduces the next LTE-U ON window 255 to increase an opportunity for other wireless communication devices to occupy a channel of the unlicensed band 230.

On the other hand, if it is determined that channel occupancy rates of other communication devices with respect to a channel of the unlicensed band 230 in the LTE-U OFF window 245 are low, the LTE-U base station 200 increases the LTE-U ON window 255 to increase a transmission opportunity of the LTE-U base station 200.

However, a method for changing setting of the LTE-U ON window and/or the LTE-U OFF window in the unlicensed band 230 is merely an example, and the LTE-U ON window and the LTE-U OFF window may be adjusted or reset based on various methods including a method using information about other wireless communication devices.

Generally, among devices supporting a plurality of wireless communication systems, a small-size device, e.g., a UE, may be limited regarding installation of an antenna used for data transmission and reception due to size limitation of the device. Thus, it is typical that in a small-size device, such as a mobile communication terminal, capable of performing wireless communication using the LTE-U system and the Wi-Fi system that use the unlicensed band, at least one antenna is shared and used for a plurality of wireless communication systems.

Thus, an antenna shared and used among the plurality of wireless communication systems may not transmit and receive data at the same time to and from respective systems, e.g., the LTE-U system and the Wi-Fi system. In other words, if a device supporting a plurality of wireless communication systems uses an identical antenna for the plurality of wireless communication systems, data may not be transmitted and received to and from the plurality of wireless communication systems at the same time. Therefore, the device may perform communication for the plurality of wireless communication systems temporally separately.

The Wi-Fi system may be forced to perform an operation of periodically or aperiodically activating the Wi-Fi system in the unlicensed band and scanning the unlicensed band due to a need of Wi-Fi coverage management or a particular operating system (OS) or application (e.g., to provide a location service of Google). In other words, even when a user of a device sets Wi-Fi to be deactivated, Wi-Fi scanning for the unlicensed band may be performed due to a need of a system, OS, or application using Wi-Fi. The user may set some devices to activate the Wi-Fi scanning operation for the unlicensed band at all times.

Thus, for a UE (hereinafter, referred to as an LTE-U UE) capable of performing communication with both the LTE-U system and the Wi-Fi system and performing communication with the respective systems via an identical antenna, the Wi-Fi scanning operation for the unlicensed band may not be performed while performing communication with the LTE-U system. In particular, if the LTE-U base station continuously uses the unlicensed band to communicate with the LTE-U UE like in the LTE-U system, the LTE-U UE has to continuously use the antenna for communication with the LTE-U base station because it is not capable of predicting when occupancy of the unlicensed band by the LTE-U base station is terminated. As a result, the LTE-U UE may not perform the Wi-Fi scanning operation properly.

If the LTE-U UE supporting communication with the Wi-Fi system does not know information regarding unlicensed band channel occupy time and channel unoccupy time of the LTE-U base station, the LTE-U UE may not normally perform communication (e.g., Wi-Fi system scanning) with the Wi-Fi system. However, if the LTE-U UE has already known information regarding unlicensed band channel occupy time and channel unoccupy time of the LTE-U base station, the LTE-U UE may perform communication with the Wi-Fi system during the unlicensed band channel unoccupy time.

Therefore, in an embodiment of the present disclosure, a description will be made of a method for setting, by the LTE-U base station, at least one of the LTE-U period, the LTE-U ON window, which is the channel occupy time of the unlicensed band, and the LTE-U OFF window, which is the channel unoccupy time of the unlicensed band, and an operation method of the LTE-U UE having received information about the set LTE-U period, LTE-U ON window, and LTE-U OFF window.

The LTE-U base station (hereinafter, referred to as a base station) capable of performing LTE/LTE-A communication in the licensed band and the unlicensed band may perform communication by setting one or more channels of the licensed band as a PCell and one or more channels of the licensed band or unlicensed band as an SCell in an LTE-U UE (hereinafter, referred to as a UE) capable of performing LTE/LTE-A mobile communication in the licensed band and the unlicensed band using CA, considering CA capabilities of the base station and the UE. Meanwhile, one channel of the unlicensed band instead of a channel of the licensed band may be set as a PCell.

The UE connects to the base station using a PCell or a channel of the licensed band. If determining to additionally allocate a frequency band (or channel) to the UE because there is much data to be transmitted to the UE, the base station instructs or sets addition of at least one of a channel of the licensed band used for communication with the UE and channels of another licensed band except for PCell to the UE as SCell or PSCell, or instructs or sets addition of at least one of channels of the unlicensed band to the UE as SCell.

Depending on the CA capabilities of the base station and the UE, a plurality of channels of the licensed band and/or a plurality of channels of the unlicensed band may be set as SCell for communication. While it is assumed that the base station sets one channel of the licensed band as PCell in the UE and one channel of the unlicensed band as SCell for communication for ease of a description, the present disclosure may also be applied to a case where a plurality of channels of the licensed band and/or a plurality of channels of the unlicensed band are set as SCell for communication.

A message for a base station to indicate addition of one of channels of an unlicensed band as SCell to a UE may be, for example, as shown in Table 1.

TABLE 1

| | |
|---|---|
| SCellToAddMod-r10 ::= | SEQUENCE { |

| | |
|---|---|
| sCellIndex-r10 | SCellIndex-r10, |

| | |
|---|---|
| cellIdentification-r10 | SEQUENCE { |

| | |
|---|---|
| physCellId-r10 | PhysCellId, |

| | |
|---|---|
| dl-CarrierFreq-r10 | ARFCN-ValueEUTRA |

}

OPTIONAL, -- Cond SCellAdd

| radioResourceConfigCommonSCell-r10 | | |
|---|---|---|
| RadioResourceConfigCommonSCell-r10 OPTIONAL, -- Cond SCellAdd | | |
| radioResourceConfigDedicatedSCell-r10 | | |
| RadioResourceConfigDedicatedSCell-r10 | OPTIONAL, -- | Cond |

SCellAdd2

| ..., | | |
|---|---|---|
| [[ | dl-CarrierFreq-v1090 | ARFCN-ValueEUTRA- |

| | |
|---|---|
| v9e0 | OPTIONAL -- Cond EARFCN-max |
| | ]] |

}

Table 1 shows a format of a message for providing information about SCell to be added by a base station to a UE connecting to the base station by using PCell or a channel or a licensed band. The message may be sent to the UE by using PCell or the channel of the licensed band and may be sent via an RRC connection reconfiguration message or another message.

Referring to Table 1, sCellToAddMod-r10 indicates a list of SCells to be added (sCellToAddModList) and includes information as provided below. sCellIndex-r10 indicates an index of SCell to be added, and cellIdentification-r10 includes physCellId-r10 and dl-CarrierFreq-r10 as cell identification information. physCellId-r10 indicates a cell ID of SCell to be added and dl-CarrierFreq-r10 indicates an operating frequency (channel) of SCell to be added. radioResourceConfigCommonSCell-r10 indicates DL configuration information (e.g., a DL bandwidth, the number of antenna ports, etc.) of SCell to be added, and radioResourceConfigDedicatedSCell-r10 indicates DL dedicated information (e.g., transmission mode information, reference signal information, etc.) specific to the UE of the SCell to be added. Once receiving the message, the UE acquires information (e.g., sCellIndex-r10, physCellId-r10, dl-CarrierFreq-r10, etc.) about SCell to be added according to radioResourceConfigCommonSCell-r10 and/or radioResourceConfigDedicatedSCell-r10. Thus, using information of sCellToAddModList, the UE determines whether SCell set or instructed to be added by the base station (hereinafter, referred to as ‘SCell to be added’) is SCell operating in the licensed band or SCell operating in the unlicensed band. In other words, the UE determines an operating frequency band of SCell to be added, based on at least one (e.g., dl-CarrierFreq-r10) of information included in SCellToAddMod-r10.

The UE determines an operating frequency band of SCell to be added, based on operating frequency band information (E-UTRA operating band information) defined in advance as shown in Table 2.

TABLE 2

| E-UTRA | Uplink (UL) operating band | Downlink (DL) operating band | |
|---|---|---|---|
| operating | BS receive UE transmit | BS transmit UE receive | Duplex |
| band | F_{UL}_{_{—}}_{low}-F_{UL}_{_{—}}_{high} | F_{DL}_{_{—}}_{low}-F_{DL}_{_{—}}_{high} | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6 (NOTE 1) | 830 MHz-840 MHz | 875 MHz-885 MHz | FDD |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23 | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| 27 | 807 MHz-824 MHz | 852 MHz-869 MHz | FDD |
| 28 | 703 MHz-748 MHz | 758 MHz-803 MHz | FDD |
| 29 | N/A | 717 MHz-728 MHz | FDD |
| 30 | 2305 MHz-2315 MHz | 2350 MHz-2360 MHz | FDD (NOTE 2) |
| 31 | 452.5 MHz-457.5 MHz | 462.5 MHz-467.5 MHz | FDD |
| 32 | N/A | 1452 MHz-1496 MHz | FDD (NOTE 2) |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz 2690 MHz | 2496 MHz 2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |
| 44 | 703 MHz-803 MHz | 703 MHz-803 MHz | TDD |
| . . . | | | |
| 252 | N/A | 5150 MHz-5250 MHz | FDD (NOTE 2) |
| 253 | Reserved | Reserved | FDD |
| 254 | Reserved | Reserved | FDD |
| 255 | N/A | 5725 MHz-5850 MHz | FDD (NOTE 2) |

(NOTE 1):
Band 6 is not applicable.
(NOTE 2):
Restricted to E-UTRA operation when carrier aggregation is configured. The downlink operating band is paired with the uplink operating band (external) of the carrier aggregation configuration that is supporting the configured Pcell.

For example, if E-UTRA operating band of SCell to be added is set to 252 or 255 (or one of E-UTRA operating bands defined as the unlicensed band in advance) of Table 2, the UE may determine that SCell to be added is SCell operating in the unlicensed band. If a UL/DL operating band of E-UTRA operating band of SCell to be added is 2.4 GHz or 5 GHz, the UE may determine that SCell to be added is SCell operating in the unlicensed band.

If SCell to be added is SCell operating in the unlicensed band, at least one of configurations of SCell to be added may be set different from PCell, PSCell, or SCell operating in the licensed band.

Meanwhile, determination of whether SCell to be added is SCell operating in the licensed band or SCell operating in the unlicensed band based on the E-UTRA operating band and/or UL/DL operating band has been provided as an example, and various methods such as determining, by the UE, an operating band of SCell to be added based on E-UTRA CA Band, EUTRA absolute radio-frequency channel number (EARFCN), or the like may be used. In another way, it does not matter whether the UE does not know the SCell to be added is SCell operating in the licensed band or SCell operating in the unlicensed band.

The UE determines a duplex mode of SCell to be added based on dl-CarrierFreq-r10 of SCell to be added. Referring to Table 2, if E-UTRA operating band of SCell to be added is set to 44 of Table 2, the UE determines that SCell to be added is SCell operating in a time division duplexing (TDD) mode. For SCell operating in the frequency division duplexing (FDD) mode where only a DL exists because E-UTRA operating band is set to 252, a UL for SCell to be added may be used in association with the UL (e.g., UL of PCell) of the licensed band.

The UE instructed by the base station to add SCell corresponding to sCellIndex of sCellToAddModList as SCell acquires information about SCell to be added (e.g., a bandwidth, physical hybrid-automatic repeat request (ARQ) indicator channel (PHICH), TDD configuration information, etc.) based on radioResourceConfigCommonSCell-r10 and radioResourceConfigDedicatedSCell-r10.

Table 3 shows radioResourceConfigCommonSCell-r10.

TABLE 3

| | |
|---|---|
| RadioResourceConfigCommonSCell-r10 ::= | SEQUENCE { |

-- DL configuration as well as configuration applicable for DL and UL

| | |
|---|---|
| nonUL-Configuration-r10 | SEQUENCE { |

| -- 1: Cell characteristics | |
|---|---|
| dl-Bandwidth-r10 | ENUMERATED {n6, n15, n25, n50, n75, |

n100},

| -- 2: Physical configuration, general | |
|---|---|
| antennaInfoCommon-r10 | AntennaInfoCommon, |
| mbsfn-SubframeConfigList-r10 | MBSFN-SubframeConfigList |

| | |
|---|---|
| OPTIONAL, | -- Need OR |

| -- 3: Physical configuration, control | |
|---|---|
| phich-Config-r10 | PHICH-Config, |

| -- 4: Physical configuration, physical channels | |
|---|---|
| pdsch-ConfigCommon-r10 | PDSCH-ConfigCommon, |
| tdd-Config-r10 | TDD-Config |

| | |
|---|---|
| OPTIONAL | -- Cond TDDSCell |

```
  },
  -- UL configuration
```

| ul-Configuration-r10 | | SEQUENCE { |
|---|---|---|
| | ul-FreqInfo-r10 | SEQUENCE { |

| | |
|---|---|
| ul-CarrierFreq-r10 | ARFCN-ValueEUTRA |

| | |
|---|---|
| OPTIONAL, | --Need OP |

| | |
|---|---|
| ul-Bandwidth-r10 | ENUMERATED {n6, n15, |

n25, n50, n75, n100}

OPTIONAL, --Need OP

| | |
|---|---|
| additionalSpectrumEmissionSCell-r10 | AdditionalSpectrumEmission |

| }, | |
|---|---|
| p-Max-r10 | P-Max |

OPTIONAL, --Need OP

uplinkPowerControlCommonSCell-r10

UplinkPowerControlCommonSCell-r10,

| -- A special version of IE UplinkPowerControlCommon may be introduced | |
|---|---|
| -- 3: Physical configuration, control | |
| soundingRS-UL-ConfigCommon-r10 | SoundingRS-UL-ConfigCommon, |

| | |
|---|---|
| ul-CyclicPrefixLength-r10 | UL-CyclicPrefixLength, |

| -- 4: Physical configuration, physical channels | |
|---|---|
| prach-ConfigSCell-r10 | PRACH-ConfigSCell-r10 |

| | |
|---|---|
| OPTIONAL, | -- Cond TDD-OR-NoR11 |

| | |
|---|---|
| pusch-ConfigCommon-r10 | PUSCH-ConfigCommon |

```
  }
OPTIONAL, --Need OR
  ...,
```

| | | |
|---|---|---|
| [[ | ul-CarrierFreq-v1090 | ARFCN-ValueEUTRA-v9e0 |

| | |
|---|---|
| OPTIONAL | -- Need OP |

]],

| | | |
|---|---|---|
| [[ | rach-ConfigCommonSCell-r11 | RACH-ConfigCommonSCell-r11 |

| | |
|---|---|
| OPTIONAL, | -- Cond ULSCell |

| | |
|---|---|
| prach-ConfigSCell-r11 | PRACH-Config |

| | |
|---|---|
| OPTIONAL, | -- Cond UL |

| | |
|---|---|
| tdd-Config-v1130 | TDD-Config-v1130 |

OPTIONAL, -- Cond TDD2

uplinkPowerControlCommonSCell-v1130

UplinkPowerControlCommonSCell-v1130

OPTIONAL-- Cond UL
]]
}

As shown in Table 3, radioResourceConfigCommonSCell-r10 may or may not include tdd-Config-r10 as TDD configuration information. If a duplex mode for E-UTRA operating band of SCell to be added is not a TDD mode as shown in the foregoing example, radioResourceConfigCommonSCell-r10 for SCell to be added may not include tdd-Config-r10 because the base station does not set tdd-Config-r10 for SCell to be added. Even if the base station sets tdd-Config-r10 and thus tdd-Config-r10 is included in radioResourceConfigCommonSCell-r10, the UE having determined that the duplex mode of SCell to be added is the FDD mode based on dl-CarrierFreq-r10 of SCell to be added may ignore tdd-Config-r10.

That is, if the duplex mode of SCell to be added is not TDD, the base station may not set tdd-Config-r10 in radioResourceConfigCommonSCell-r10, or even if the base station sets tdd-Config-r10 in radioResourceConfigCommonSCell-r10, the UE may ignore the tdd-Config-r10 configuration information.

If the base station sets set tdd-Config-r10 in radioResourceConfigCommonSCell-r10 even when the duplex mode of SCell to be added is not TDD (e.g., FDD or DL FDD), the UE and the base station make a previous definition to use the set tdd-Config-r10 or the UE re-interprets the set tdd-Config-r10 for use in communication between the base station and the UE.

An embodiment of the present disclosure proposes a method in which the base station sets a window (LTE-U ON window) where the base station occupies a channel of an unlicensed band of SCell and/or a window (LTE-U OFF window) where the base station does not occupy a channel of the unlicensed band and delivers information about the set windows to the UE by using tdd-Config-r10 among information included in radioResourceConfigCommonSCell-r10 of SCell. For example, the base station may set a window corresponding to a DL subframe as the LTE-U ON window and a window corresponding to a UL subframe as the LTE-OFF window in TDD UL/DL configuration corresponding to the set tdd-Config-r10, based on TDD UL/DL configuration information (hereinafter, referred to as a ‘TDD UL/DL configuration’) corresponding to the set tdd-Config-r10.

Thus, the UE may know in advance the LTE-U ON window and the LTE-U OFF window based on tdd-Config-r10. The UE then communicates with SCell by using the LTE-U ON window and performs transmission and reception with another wireless communication system (e.g., the Wi-Fi system) by using the LTE-U OFF window.

As such, by allowing the UE to know the channel occupy time and unoccupy time of one wireless communication system (or a wireless communication system operating time), the UE may use a plurality of wireless communication systems in a more useful way.

In the TDD UL/DL configuration corresponding to the set tdd-Config-r10, a special subframe is regarded as a DL subframe or a UL subframe and thus is set as the LTE-U ON window or the LTE-U OFF window. A 1 ms subframe of the set TDD UL/DL configuration may be predefined, or may be re-interpreted by being increased or reduced to Nms based on a time scale that is set by the base station. This is described below in greater detail.

For example, for SCell operating in the FDD or a DL dedicated FDD in the unlicensed band, the base station sets tdd-Config-r10 (or tdd-Config) in radioResourceConfigCommonSCell-r10 and transfers the message to the UE. The base station sets or re-interprets the set tdd-Config for SCell to mean at least one of the LTE-U ON window and/or the LTE-U OFF window of the base station.

More specifically, among subframes corresponding to tdd-Config set by the base station for SCell, a DL subframe indicates the LTE-U ON window and a UL subframe indicates the LTE-U OFF window. If a special subframe is included among the subframes corresponding to tdd-Config set for SCell, the entire special subframe or a part thereof may be interpreted as one of the DL subframe and the UL subframe.

For example, if the special subframe is interpreted as a DL subframe, the base station sets a window corresponding to the special subframe for SCell as the LTE-U ON window. If the special subframe is interpreted as a UL subframe, the base station sets a window corresponding to the special subframe for SCell as the LTE-U OFF window.

A part of a window included in the special subframe may be set as at least one of a DL subframe and a UL subframe.

Some of a downlink pilot time slot (DwPTS) window, a guard window, and an uplink pilot time slot (UpPTS) window included in the special subframe may be set as at least one of a DL subframe and a UL subframe. For example, the DwPTS window or the DwPTS window and the guard window may be set as a DL subframe, and the UpPTS window or the guard window and the UpPTS window may be set as a UL subframe. Thus, the special subframe may include both the LTE-U ON window and the LTE-U OFF window.

If a plurality of special subframes corresponding to the set tdd-Config exist, the base station sets at least one of a plurality of special subframes as a DL subframe and another special subframe of the plurality of special subframes as a UL subframe. In another way, the base station sets all of the plurality of special subframes as a DL subframe or a UL subframe.

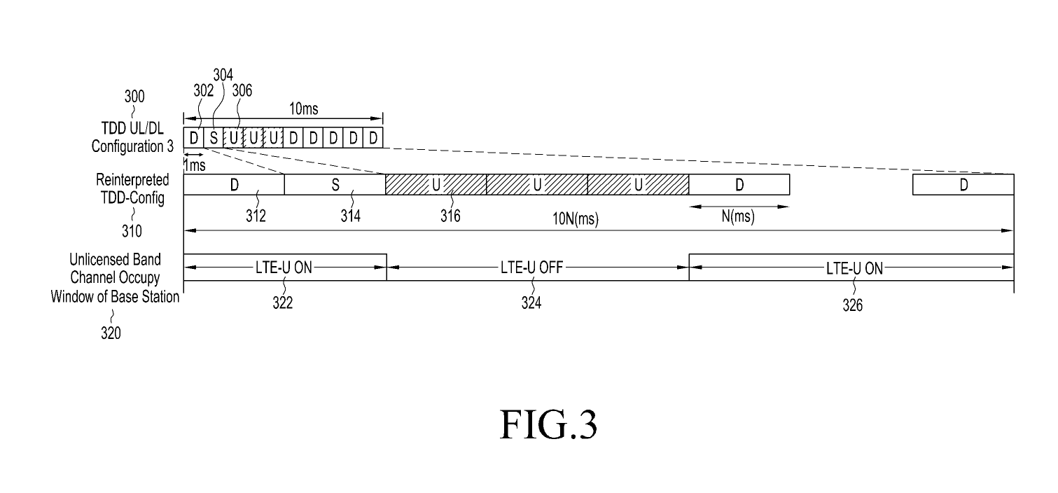

Meanwhile, for SCell operating in TDD in the unlicensed band, according to previous definition between the base station and the UE or configuration of the base station, a window corresponding to a DL subframe among subframes corresponding to tdd-Config set for SCell indicates the LTE-U ON window and a window corresponding to a UL subframe among the subframes corresponding to tdd-Config indicates the LTE-U OFF window. This is described below with reference to FIG. 3.

FIG. 3 illustrates an example of a TDD UL/DL configuration in an unlicensed band according to an embodiment of the present disclosure.

Referring to FIG. 3, the UE is instructed to add SCell by the base station (PCell or the licensed band) to which the UE is connected. The UE may receive system or control information (e.g., radioResourceConfigCommonSCell-r10) or the like for SCell from the base station (PCell or the licensed band). The UE then determines, based on at least one of dl-CarrierFreq-r10 and physCellId-r10 for SCell set by the base station, that SCell is SCell operating in the unlicensed band channel and in FDD or DL dedicated FDD (or predefined duplex).

As such, if tdd-Config-r10 for SCell operating in FDD (or DL dedicated FDD) in a channel of the unlicensed band is set to TDD UL/DL Configuration 3 300 among TDD UL/DL configurations set in advance, the UE determines the LTE-U ON window and/or the LTE-U OFF window based on TDD UL/DL Configuration 3 300.

For example, the UE may determine a window corresponding to a DL subframe 302 among subframes corresponding to TDD UL/DL Configuration 3 300 as the LTE-U ON window. The UE may determine a window corresponding to a UL subframe 306 among subframes corresponding to TDD UL/DL Configuration 3 300 as the LTE-U OFF window.

If a special subframe 304 is included in subframes corresponding to TDD UL/DL Configuration 3 300, the UE interprets the special subframe 304 as the DL subframe 302 and determines a window corresponding to the special subframe 304 as the LTE-U ON window. In another way, the UE interprets the special subframe 304 as a UL subframe 306 and determines the window corresponding to the special subframe 304 as the LTE-U OFF window. If a plurality of special subframes exist, some of the plurality of special subframes are interpreted as DL subframes (e.g., DwPTS and guard windows) and the remaining special subframes are interpreted as UL subframes (e.g., an UpPTS window) and the special subframes may be used for both the LTE-U ON window and the LTE-U OFF window. The UE applies a time scale of tdd-Config-r10 (or TDD UL/DL configuration) set for SCell by the base station to re-interpret the set tdd-Config-r10 (or TDD UL/DL configuration). For example, to interpret a time scale for TDD UL/DL Configuration 3 300 set by the base station via tdd-Config-r10 as a temporal extension of N times, the base station and the UE may previously make a definition, or the base station may transmit the configuration information to the UE via a high-layer signal. The UE then re-interprets TDD UL/DL Configuration 3 300 set by the base station as in TDD UL/DL Configuration 310.

In other words, a 1 ms-based subframe of TDD UL/DL Configuration 3 300 is re-interpreted as an Nms-based subframe, including DL subframe 312, special subframe 314 and UL subframe 316. And, if the base station and the UE previously make a definition that the base station does not occupy the unlicensed band in a subframe set as a UL among subframes corresponding to TDD UL/DL Configuration 3 300 set for SCell by the base station in the UE, the UE may predict that the base station is not to occupy a channel of the unlicensed band in a window 324 corresponding to the UL subframe.

If the base station and the UE make a previous definition that the base station occupies a channel of the unlicensed band 320 in a subframe set as a DL and a special subframe among the subframes corresponding to TDD UL/DL Configuration 3 300, the UE may determine that the base station is to occupy the channel of the unlicensed band 320 in windows 322 and 326 corresponding to the DL subframe.

If the special subframe 304 exists, the UE interprets the special subframe 304 like the DL subframe 302 and interprets a window corresponding to the special subframe 304 as an LTE-U ON window 322. In another way, the UE interprets the special subframe 304 as the UL subframe 306 and determines the window corresponding to the special subframe 304 as the LTE-U OFF window 324. Some of the plurality of special subframes are interpreted as DL subframes (e.g., DwPTS and guard windows) and the remaining special subframes are interpreted as UL subframes (e.g., an UpPTS window), and the special subframes may be used for both the LTE-U ON window and the LTE-U OFF window.

As such, the UE may know the LTE-U ON window and the LTE-U OFF window based on the TDD UL/DL configuration and the time scale that are set by the base station. Thus, the UE performs communication with the base station according to the LTE or LTE-U communication system in the LTE-U ON window, and performs communication with a system performing wireless communication (e.g., Bluetooth) including the Wi-Fi system via another unlicensed band in the LTE-U OFF window.

If UL transmission corresponding to the DL of SCell is not set (e.g., DL dedicated FDD), the base station sets a time scale for TDD UL/DL configuration to be notified to the UE by using a configuration of phich-Config-r10 in radioResourceConfigCommonSCell-r10. That is, if UL transmission corresponding to the DL of SCell does not exist, the base station sets a time scale N for TDD UL/DL configuration in the UE by using unnecessary PHICH configuration information (i.e., PHICH-Config).

The following Table 4 indicates PHICH-Config.

TABLE 4

| | |
|---|---|
| PHICH-Config ::= | SEQUENCE { |

| | | |
|---|---|---|
| phich-Duration | | ENUMERATED |
| | {normal, extended}, | |
| phich-Resource | | ENUMERATED |
| | {oneSixth, half, one, two} | |
| } | | |

Referring to Table 4, if phich-Duration of PHICH-Config is set normal, the UE determines the PHICH-Config as PHICH-Config used for existing LTE communication. In this case, the UE uses PHICH-Config according to PHICH-Config interpretation and operation scheme prior to Release 12 used in the licensed band.

However, if the operating frequency band of SCell is the unlicensed band, a UL channel corresponding to SCell is not set, and the phich-Duration is set to be extended, the base station and the UE differently set a time scale for TDD UL/DL configuration via phich-Resource.

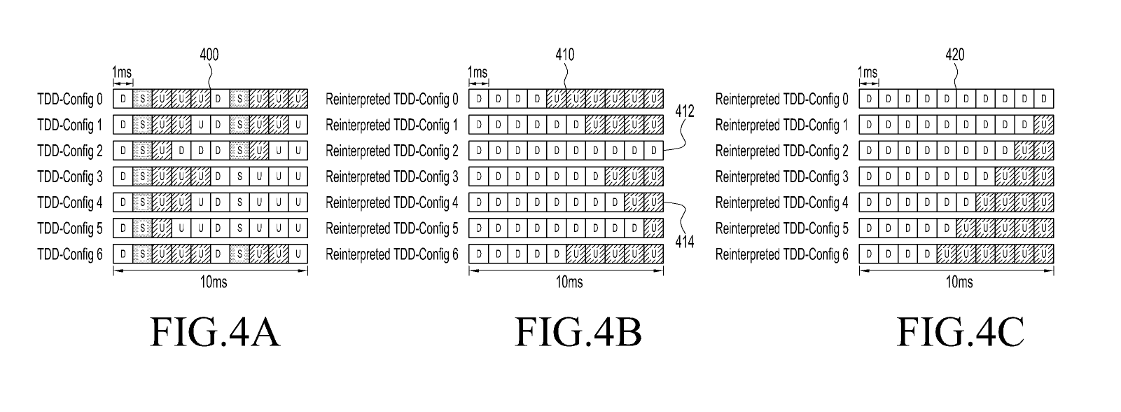

For example, if the operating frequency band of S Cell is an unlicensed band and the phich-Duration is set to be extended, the UE may interpret phich-Resource {1/6, 1/2, 1, 2} as {10, 20, 50, 100} according to a TDD UL/DL configuration time scale (N). More specifically, if the operating frequency band of SCell is an unlicensed band, the phich-Duration is set to be extended, and the phich-Resource is set to “one”, then the UE interprets a time scale of the TDD UL/DL configuration set by the base station as 50 and interprets the set scale of the TDD UL/DL configuration as 50 times thereof. The UE and the base station may reconfigure or reinterpret a TDD UL/DL configuration structure for SCell operating in the unlicensed band. With reference to FIGS. 4A, 4B, and 4C, a description will be made of a method for reconfiguring or reinterpreting, by the UE and the base station, a TDD UL/DL configuration structure set for SCell.

FIGS. 4A, 4B, and 4C illustrate an example of a reinterpreted TDD UL/DL configuration according to an embodiment of the present disclosure.

As such, the UE may determine the LTE-U ON window and the LTE-U OFF window based on the TDD UL/DL configuration set by the base station. The TDD UL/DL configuration may be one of TDD UL/DL Configurations 0-6 400 defined in the existing TS36.211 document shown in FIG. 4A. If the TDD UL/DL configuration set for S Cell is determined, the UE determines the LTE-U ON window and the LTE-U OFF window based on the method described with reference to FIG. 3.

For example, the UE may determine a window corresponding to a DL subframe among subframes corresponding to TDD UL/DL Configuration 1 as the LTE-U ON window, if the set TDD UL/DL configuration is TDD UL/DL Configuration 1. The UE may determine a window corresponding to a UL subframe among the subframes corresponding to TDD UL/DL Configuration 1 as the LTE-U OFF window.

The UE may interpret a special subframe among the subframes corresponding to TDD UL/DL Configuration 1 as a DL subframe and determine a window corresponding to the special subframe as the LTE-U ON window. In another way, the UE may interpret the special subframe as a UL subframe and determine a window corresponding to the special subframe as the LTE-U OFF window. Some windows included in the special subframe (e.g., the DwPTS window and the guard window) are interpreted as DL subframes and the remaining windows (e.g., the UpPTS window) are interpreted as UL subframes, and the special subframes may be used for both the LTE-U ON window and the LTE-U OFF window.

The UE may use the existing TDD UL/DL Configuration 400 as shown in FIG. 4A via reinterpretation without changing the TDD UL/DL Configuration 400, but may also use the TDD UL/DL Configuration 400 after changing the TDD UL/DL Configuration 400 as described below.

As shown in FIG. 4B, in the existing TDD UL/DL Configuration 400, the UE may perform interpretation by changing the position of the UL subframe while keeping the number of UL subframes identical. For example, the UE may reset the TDD UL/DL Configuration 400 as TDD UL/DL Configuration 410 such that successive UL subframes follow successive DL subframes. While the special subframe is defined as the DL subframe in an embodiment of the present disclosure, the special subframe may also be defined as the UL subframe. Some of the special subframes may be defined as DL subframes and the remaining special subframes may be defined as UL subframes.

TDD UL/DL Configurations 2 and 4 have the same number of UL subframes, i.e., two UL subframes. Thus, one of the TDD UL/DL Configurations 2 and 4 may be reinterpreted as new TDD UL/DL configuration. For example, TDD UL/DL Configuration 4 may be reset such that successive UL subframes follow successive DL subframes as indicated by 414 in FIG. 4B, and TDD UL/DL Configuration 2 may be reinterpreted as a DL dedicated TDD configuration without a UL subframe as indicated by 412 in FIG. 4B. In this case, the UE may determine that it continuously occupies the unlicensed band, because only the LTE-U ON window exists without the LTE-U OFF window.

As another example where the existing TDD UL/DL configuration is changed for use, as shown in FIG. 4C, the base station and the UE may newly define and reinterpret the TDD UL/DL configuration regardless of the number of UL or DL subframes of the TDD UL/DL Configuration 400. In FIG. 4C, the TDD UL/DL configuration is reset to include UL subframes of the same number as the index of the TDD UL/DL Configuration 420. For example, TDD UL/DL Configuration 0 does not include a UL subframe, TDD UL/DL Configuration 1 includes one UL subframe, TDD UL/DL Configuration 2 includes two UL subframes, TDD UL/DL Configuration 3 includes three UL subframes, TDD UL/DL Configuration 4 includes four UL subframes, TDD UL/DL Configuration 5 includes five UL subframes, and TDD UL/DL Configuration 6 includes six UL subframes.

Meanwhile, a method for reinterpreting a TDD UL/DL configuration may be performed in various manners including FIGS. 4A, 4B, and 4C. If a time scale of the reinterpreted TDD UL/DL configuration is defined in advance between the base station and the UE or is set to N by setting of the base station, the LTE-U ON window and/or the LTE-U OFF window may be expanded by the set time scale and reinterpreted with respect to FIGS. 4A, 4B, and 4C.

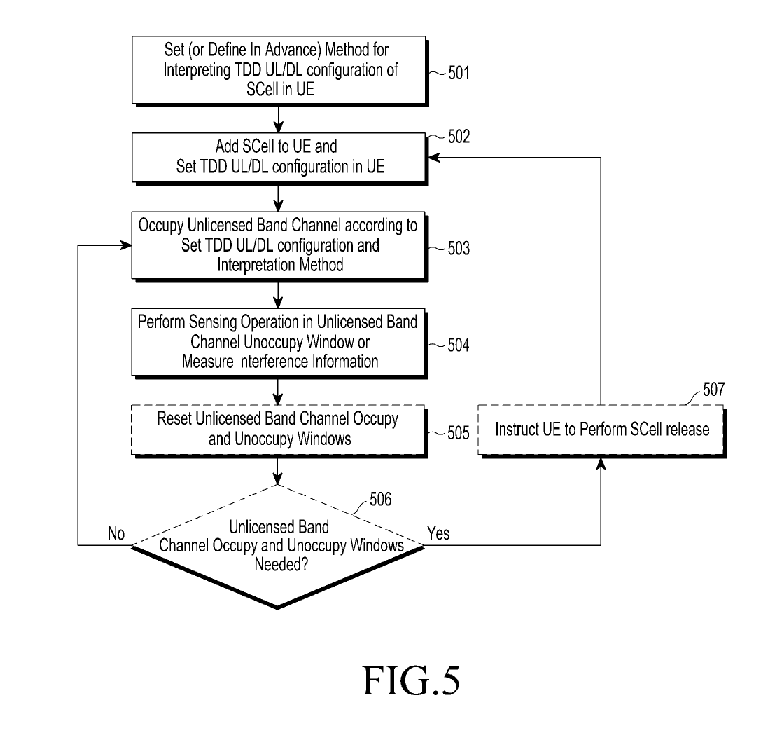

FIG. 5 is a flowchart illustrating a base station operation according to an embodiment of the present disclosure.

Referring to FIG. 5, in operation 501, the base station sets TDD UL/DL configuration related control information. The control information may include at least one of a method for interpreting TDD UL/DL configuration for SCell instructed or set in the UE to be added by the base station, and/or a time scale unit of TDD UL/DL configuration, and a method for interpreting a UL, a DL, and a special subframe of TDD UL/DL configuration. The control information may be defined in advance between the base station and the UE, or may be set in the UE by the base station via high-layer signaling.

In operation 502, the base station sets a window (LTE-U ON window) where a channel of an unlicensed band is occupied and a window (LTE-U OFF window) where a channel of the unlicensed band is not occupied for SCell. The base station sets tdd-Config-r10 based on the set window information and informs the UE of the LTE-U ON window and the LTE-U OFF window.

For example, if SCell set in the UE by the base station is SCell operating in the FDD mode in unlicensed band channel and tdd-Config-r10 is set therein, the UE interprets a DL and a special subframe window in tdd-Config-r10 as the LTE-U ON window and interprets a UL subframe as the LTE-U OFF window.

If the time scale N is defined in advance for TDD UL/DL configuration or is set via a high-layer signal from the base station, the DL and special subframe windows are interpreted as the LTE-U ON window using the set time scale and interprets the UL subframe window as the LTE-U OFF window by using the set time scale.

In operation 503, the base station occupies the channel of the unlicensed band in the LTE-U ON window for communication, by using the time scale set for the DL and special subframes among subframes corresponding to the TDD UL/DL configuration set in the UE.

In operation 504, the base station does not occupy the channel of the unlicensed band in the LTE-U OFF window for communication, by using the time scale set for the UL subframe among the subframes corresponding to the TDD UL/DL configuration set in the UE.

In operation 505, in the LTE-U OFF window, SCell monitors the channel of the unlicensed band or measures interference strength and uses the result for setting the unlicensed band occupy window and the unlicensed band unoccupy window by S cell. In operation 506, it is determined if unlicensed band channel occupy and unoccupy windows are needed. If setting of the unlicensed band occupy window and the unlicensed band unoccupy window by Scell to be used by SCell measured and determined in operation 505, that is, TDD UL/DL configuration corresponding to the unlicensed band occupy window and the unlicensed band unoccupy window to be used by SCell later is different from TDD UL/DL configuration set in operation 502, the base station may instruct or set SCell of the UE to be released.

The base station instructs or sets the UE to add SCell and sets the changed TDD UL/DL configuration. For a base station and a UE supporting enhancements to LTE TDD for DL-UL interference management and traffic adaptation (eIMTA) signaling, the TDD UL/DL configuration of SCell may be reset by eIMTA signaling instead of SCell release or a PDCCH having a cyclic redundancy check (CRC) scrambled by eIMTA-radio network temporary identifier (RNTI) in operation 507. In addition, operations 506 and 507 may be skipped, and the base station may use identical TDD UL/DL configuration.

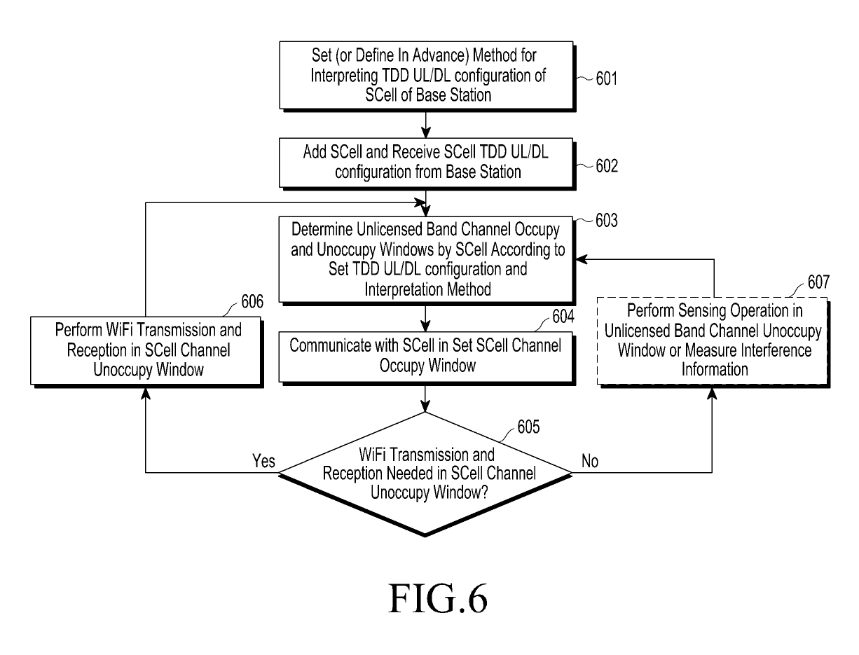

FIG. 6 is a flowchart illustrating a UE operation according to an embodiment of the present disclosure.

Referring to FIG. 6, a UE receives TDD UL/DL configuration control information from a base station in operation 601. The TDD UL/DL configuration control information may include at least one of information about a method for interpreting TDD UL/DL configuration for SCell to be added, information about a time scale unit of TDD UL/DL configuration, and information about a method for interpreting a UL, a DL, and a special subframe of TDD UL/DL configuration. The TDD UL/DL configuration control information may be previously defined between the UE and the base station, or may be included in high-layer signaling received from the base station.

The UE receives information about SCell to be added from the base station in operation 602. The information about SCell to be added may include an ID of SCell to be added, operating frequency information of SCell to be added, TDD UL/DL configuration of SCell to be added, and so forth. For a UE that is set to decode a PDCCH obtained by performing CRC scrambling with respect to the TDD UL/DL configuration using eIMTA-RNTI, the TDD UL/DL configuration of SCell may be reset in the UE by the base station using the PDCCH having the CRC scrambled by eIMTA-RNTI.

In operation 603, if S Cell set in the UE by the base station is S Cell operating in the unlicensed band channel and operating in FDD duplex mode and tdd-Config-r10 is set therein, the UE interprets a window corresponding to DL and special subframes among subframes corresponding to tdd-Config-r10 as the LTE-U ON window and interprets a window corresponding to a UL subframe as the LTE-U OFF window.

If the time scale N set for the TDD UL/DL configuration is defined in advance, the UE interprets a window corresponding to the DL subframe and the special subframe as the LTE-U ON window by using the set time scale, and interprets a window corresponding to the UL subframe as the LTE-U OFF window by using the set time scale.

In operation 604, the UE performs communication with SCell in the LTE-U ON window determined in operations 603. In operation 605, if data transmission and reception to and from the Wi-Fi system or another system are necessary in the LTE-U OFF window determined in operation 603, the UE performs data transmission and reception to and from the Wi-Fi system or another system in the LTE-U OFF window in operation 606.

If transmission and reception with the Wi-Fi system or another system are not required in operation 605, the UE monitors the unlicensed band channel or measures interference of the unlicensed band channel to report a measured value to the base station in operation 607.

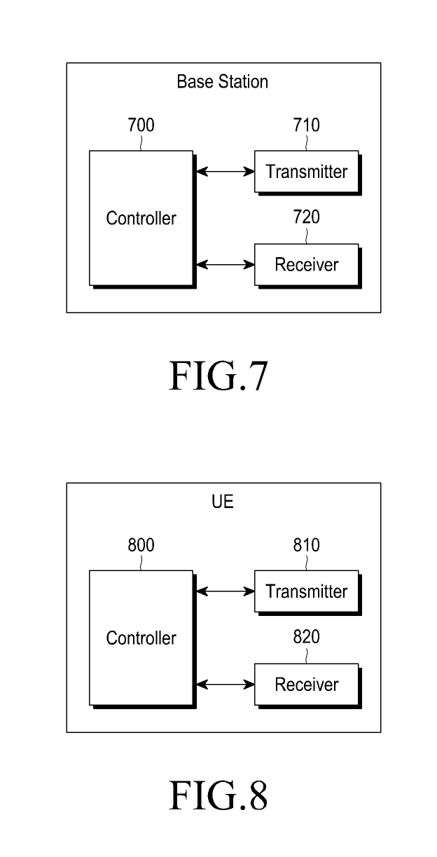

FIG. 7 is a block diagram of a base station according to an embodiment of the present disclosure.

Referring to FIG. 7, the base station may include a controller (processor) 700, a transmitter 710, and a receiver 720.

The receiver 720 may perform the operation of sensing the unlicensed band channel by using a setting value for a channel sensing operation set by the controller 700 as well as the operation of receiving a signal from another base station or the UE or measuring a channel from another base station or the UE. The controller 700 sets the LTE-U ON window and the LTE-U OFF window of the unlicensed band by using information about the unlicensed band sensed by the receiver 720. If there are a lot of activities of other devices in the sensed unlicensed band, the LTE-U ON window of the unlicensed band may be reduced. The controller 700 sets TDD UL/DL configuration of the base station operating in the unlicensed band channel and the time scale of the set TDD UL/DL configuration and transmits the set unlicensed band set value to the UE via the transmitter 710 or occupies the channel by transmitting a signal during the set unlicensed band channel occupy window.

The controller 700 sets addition or removal of SCell for a particular UE, TDD UL/DL configuration for S Cell and a time scale of the set TDD UL/DL configuration, and unlicensed band channel occupy window and unoccupy window, and notifies the UE of the set information by using the transmitter 710.

Meanwhile, the transmitter 710 and the receiver 720 are physically separated in FIG. 7, but they may also be configured as one unit capable of performing operations of the transmitter 710 and operations of the receiver 720, such as a transceiver.

FIG. 8 is a block diagram of a UE according to an embodiment of the present disclosure.

Referring to FIG. 8, the UE may include a controller (processor) 800, a transmitter 810, and a receiver 820.

Referring to FIG. 8, the controller 800 receives licensed band and unlicensed band channel or configuration information regarding SCell from the base station, and receives reinterpretation information regarding TDD UL/DL configuration of SCell operating in the unlicensed band, via the receiver 820. The controller 800 determines an occupy window and an unoccupy window for the unlicensed band channel of SCell by using TDD UL/DL configuration of SCell and the time scale that are set by the base station and received via the receiver 820. The controller 800 determines whether signal transmission/reception with other systems including a Wi-Fi system is required during the unoccupy window of the unlicensed band channel of SCell determined using TDD UL/DL configuration of SCell and the time scale that are set by the base station. Further, the controller 800 may determine the result of reception of the data signal received from the base station and may notify the base station of the data reception result via the transmitter 810. If signal transmission/reception with other systems including the Wi-Fi system is required, data transmission and reception to and from other systems are performed using the transmitter 810 and the receiver 820.

Meanwhile, the transmitter 810 and the receiver 820 are physically separated in FIG. 8, but they may also be configured as one unit capable of performing operations of the transmitter 810 and operations of the receiver 820, such as a transceiver.

According to an embodiment of the present disclosure, a device supporting a plurality of wireless communication systems receives use information of a wireless communication system in advance and uses the received information for transmission/reception by another wireless communication system, allowing efficient coexistence among wireless communication systems.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for performing communication by a user equipment (UE) in a wireless communication system, the method comprising:
receiving control information about a second cell from a first cell via a licensed band channel;
performing communication with the second cell based on a first communication scheme via an unlicensed band channel of the second cell in an occupy window of the unlicensed band channel based on the control information; and
performing communication with a third cell based on a second communication scheme via the unlicensed band channel of the second cell in an unoccupy window of the unlicensed band channel based on the control information.

2. The method of claim 1, wherein the control information comprises time division duplexing (TDD) uplink (UL)/downlink (DL) configuration information,
wherein a window corresponding to one of at least one UL subframe and at least one DL subframe based on the TDD UL/DL configuration information indicates the occupy window, and
wherein a window corresponding to the other of the at least one UL subframe and the at least one DL subframe indicates the unoccupy window.

3. The method of claim 2, wherein if at least one special subframe exists based on the TDD UL/DL configuration information, at least one of a downlink pilot time slot (DwPTS) window, a guard window, and an uplink pilot time slot (UpPTS) window indicates the occupy time, and
wherein at least one of the DwPTS window, the guard window, and the UpPTS window, which is not included in the occupy window, indicates the unoccupy window.

4. The method of claim 2, wherein the control information comprises a time scale for increasing a unit of each subframe based on the TDD UL/DL configuration information by N times for use.

5. The method of claim 4, wherein the time scale is included in physical hybrid-automatic repeat request (ARQ) indicator channel (PHICH) configuration information included in the control information if there is no UL transmission corresponding to DL data received from the second cell.

6. The method of claim 2, wherein the TDD UL/DL configuration information indicates one of a preset plurality of configuration information and is reset based on control information received based on an identifier allocated to the UE.

7. The method of claim 1, wherein a length of a next occupy window and a length of a next unoccupy window for the unlicensed band channel are determined based on at least one of interference strength and a monitoring result of the unlicensed band channel, which are measured by the second cell in the unoccupy window.

8. A method for performing communication by a first cell in a wireless communication system, the method comprising:
transmitting control information comprising information about an occupy window and an unoccupy window for an unlicensed band channel of a second cell to a user equipment (UE) via a licensed band,
wherein the occupy window indicates a window where the UE performs communication with the second cell via the unlicensed band channel based on a first communication scheme, and
wherein the unoccupy window indicates a window where the UE performs communication with a third cell via the unlicensed band channel based on a second communication scheme.

9. The method of claim 8, wherein the control information comprises time division duplexing (TDD) uplink (UL)/downlink (DL) configuration information,
wherein a window corresponding to one of at least one UL subframe and at least one DL subframe based on the TDD UL/DL configuration information indicates the occupy window, and
wherein a window corresponding to the other of the at least one UL subframe and the at least one DL subframe indicates the unoccupy window.

10. The method of claim 9, wherein if at least one special subframe exists based on the TDD UL/DL configuration information, at least one of a downlink pilot time slot (DwPTS) window, a guard window, and an uplink pilot time slot (UpPTS) window indicates the occupy time, and
wherein at least one of the DwPTS window, the guard window, and the UpPTS window, which is not included in the occupy window, indicates the unoccupy window.

11. The method of claim 9, wherein the control information comprises a time scale for increasing a unit of each subframe based on the TDD UL/DL configuration information by N times for use and N is a number greater than 0.

12. The method of claim 11, wherein the time scale is included in physical hybrid-automatic repeat request (ARQ) indicator channel (PHICH) configuration information included in the control information if there is no UL transmission corresponding to DL data received from the second cell.

13. The method of claim 9, wherein the TDD UL/DL configuration information indicates one of a preset plurality of configuration information and is reset based on control information received based on an identifier allocated to the UE.

14. The method of claim 8, wherein a length of a next occupy window and a length of a next unoccupy window for the unlicensed band channel are determined based on at least one of interference strength and a monitoring result of the unlicensed band channel, which are measured by the second cell in the unoccupy window.

15. A user equipment (UE) in a wireless communication system, the UE comprising:
a transceiver configured to receive control information about a second cell from a first cell via a licensed band channel; and
a controller configured to:
perform communication with the second cell based on a first communication scheme via an unlicensed band channel in an occupy window of the unlicensed band channel of the second cell based on the control information, and
perform communication with a third cell based on a second communication scheme via the unlicensed band channel in an unoccupy window of the unlicensed band channel of the second cell based on the control information.

16. The UE of claim 15, wherein the control information comprises time division duplexing (TDD) uplink (UL)/downlink (DL) configuration information,
wherein a window corresponding to one of at least one UL subframe and at least one DL subframe based on the TDD UL/DL configuration information indicates the occupy window, and
wherein a window corresponding to the other of the at least one UL subframe and the at least one DL subframe indicates the unoccupy window.

17. The UE of claim 16, wherein if at least one special subframe exists based on the TDD UL/DL configuration information, at least one of a downlink pilot time slot (DwPTS) window, a guard window, and an uplink pilot time slot (UpPTS) window indicates the occupy time, and
wherein at least one of the DwPTS window, the guard window, and the UpPTS window, which is not included in the occupy window, indicates the unoccupy window.

18. The UE of claim 16, wherein the control information comprises a time scale for increasing a unit of each subframe based on the TDD UL/DL configuration information by N times for use, and N is a number greater than 0.

19. The UE of claim 16, wherein the TDD UL/DL configuration information indicates one of a preset plurality of TDD UL/DL configuration information and is reset based on control information received based on an identifier allocated to the UE.

20. The UE of claim 15, wherein a length of a next occupy window and a length of a next unoccupy window for the unlicensed band channel are determined based on at least one of interference strength and a monitoring result of the unlicensed band channel, which are measured by the second cell in the unoccupy window.

21. At least one non-transitory processor readable medium for storing a computer program of instructions configured to be readable by at least one processor for instructing the at least one processor to execute a computer process for performing the method as recited in claim 1.
